(19) United States
(12) Patent Application Publication
(10) Pub. No.: US 2025/0243361 A1
(43) Pub. Date: Jul. 31, 2025

(54) LIGHT DIFFUSING THERMOPLASTIC COMPOSITION

(71) Applicant: SABIC GLOBAL TECHNOLOGIES B.V., Bergen op Zoom (NL)

(72) Inventor: Joshua Arie Van den Bogerd, Tholen (NL)

(21) Appl. No.: 18/856,205

(22) PCT Filed: Apr. 12, 2023
(86) PCT No.: PCT/EP2023/059578

§ 371 Date: Oct. 11, 2024

(30) Foreign Application Priority Data
Apr. 15, 2022 (EP) 22168631.4

(51) Int. Cl. C08L 69/00; C08F 120/14; C08K 5/3475; G02B 5/02

(52) U.S. Cl. CPC C08L 69/00; C08F 120/14; C08K 5/3475; G02B 5/0242; C08K 2201/003; C08L 2203/16; C08L 2203/20; C08L 2205/22

(57) ABSTRACT

The present invention relates to a thermoplastic composition comprising from 92.5-99.9 wt. % of a polymer composition and from 0.1-7.5 wt. % of light diffusing particles wherein at least part of the light diffusing particles consist of a resin composition comprising at least one ultraviolet stabiliser.

The present invention relates to a light diffusing thermoplastic composition comprising a polymer composition and light diffusing particles dispersed therein. The invention further relates to articles comprising or consisting of said light diffusing thermoplastic composition and to light diffuser particles.

Light diffusing thermoplastic compositions are known per se and are used in particular in lighting applications. Thus by way of example light diffusing thermoplastic compositions may be used for light diffusing sheets or plates and as lighting covers, in particular for LED lighting applications.

Articles comprising or consisting of said light diffusing compositions may be used in applications wherein they are exposed to ultraviolet radiation which may affect the color properties of the article. For example, polycarbonate has a tendency to turn yellow upon prolonged exposure to ultraviolet radiation. Solutions to reduce this problem to a minimum are known in the art. For example it is well-known to add ultraviolet stabilisers to the polymer and/or to apply a protective ultraviolet absorbing coating or cap-layer to or on the article. Alternatively, colorants such as in particular blue dyes may be used to offset the yellowing so that the observer doesn't notice the yellow(ish) color of the material.

An important property of light diffusing compositions is that for a certain amount of diffusivity the transmittance, i.e. the fraction of visible light that travels through the material, is as high as possible. For example in LED lighting applications it is desirable that on the one hand the actual LED light source is not observed, whereas at the same time the amount of light transmitted by the LED source and travelling through the light diffusing article is as high as possible. A loss in transmittance would otherwise have to be compensated by a stronger light source or by a less satisfactory light diffusion.

For this reason light diffuser particles are preferably prepared from transparent resins like acrylates, silicones or polystyrene which allows the incident light to travel through both the polymer composition as well as through the resin of the light diffusing particles. While the use of transparent resins for the light diffuser particles allows for a high transmission of visible light it also means that ultraviolet light may, at least to some extent, travel through said particles. As a result the resin of the light diffuser particles may be affected by the ultraviolet radiation or, depending on the resin, ultraviolet radiation may travel deeper into the polymer in which the light diffuser particles are dispersed, thereby risking a higher degree of yellowing over prolonged exposure to ultraviolet radiation. In the past light diffusing particles have been described in various publications. WO2016190560 relates to light diffusing powder comprising a polystyrene-based resin; and polyorganosilsesquioxane particles having an average diameter (D50) of approximately 0.1-0.9 μm.

KR20080071673 relates to a light resistant light diffusion plate, a backlight device having the same, and a liquid crystal display device. The patent application further describes a method of preparing light diffusion particles consisting of a cross-linked polymethylmethacrylate resin ultraviolet absorber.

However there remains a need to further mitigate the effects of ultraviolet radiation on light diffusing thermoplastic compositions based on a polymer composition and resin-based light diffusing particles dispersed therein.

It is an object of the present invention to further mitigate the effects of ultraviolet radiation on light diffusing thermoplastic compositions based on a polymer composition and resin-based light diffusing particles dispersed therein.

It is in particular an object to reduce the effects of ultraviolet radiation on light diffusing thermoplastic compositions comprised of polycarbonate as the polymer and acrylate resin based light diffuser particles.

The present inventors have found that the undesired effects of ultraviolet radiation can be reduced by adding an ultraviolet stabiliser to the resin composition constituting the light diffuser particle(s).

Accordingly the present invention relates to a thermoplastic composition comprising, based on the weight of the composition A) from 92.5-99.9 wt. % of a polymer composition and B) from 0.1-7.5 wt. % of light diffusing particles wherein at least part of the light diffusing particles consist of a resin composition comprising at least one ultraviolet stabiliser. In the composition of the invention it is preferred that the sum of the components (A) and (B) is 100 wt. %.

More in particular the present invention relates to a thermoplastic composition comprising, based on the weight of the composition A) from 92.5-99.9 wt. % of a polymer composition comprising polycarbonate, and B) from 0.1-7.5 wt. % of light diffusing particles, wherein at least part of the light diffusing particles consist of a cross-linked acrylic resin composition comprising at least one ultraviolet stabiliser.

While the concept underlying the present invention in principle does not impose any limitations as to the polymer composition (A) or the resin composition (B) of the light diffusing particles, the present invention in particular applies to thermoplastic compositions wherein the polymer composition comprises or consists of polycarbonate, polymethyl(meth)acrylate or a mixture of polycarbonate and polymethyl(meth)acrylate.

These materials are known to have a high visible light transmission combined with good mechanical properties and processability. Accordingly polycarbonate and polymethyl(meth)acrylate are often used polymers for lighting applications.

The concept underlying is of particular use in compositions where the transmission of UV radiation is different for the polymer composition and the resin composition of the light diffusing particles. Thus, the present invention is of particular relevance for compositions wherein the polymer composition has a lower transmission of UV radiation as compared to the UV transmission of the resin composition of the light diffusing particles.

For the purpose of the present invention the visible light spectrum is assumed to be in the 400-800 nm range so that the UV range starts at 400 nm. Bisphenol A polycarbonate allows transmission of UV radiation down to about 300 nm, but below about 300 nm polycarbonate becomes non-transparent to UV radiation. Important is that already from 400-300 nm the transparency of polycarbonate decreases significantly. Polymethyl(meth)acrylate on the other hand only becomes non-transparent to UV radiation below about 250 nm, meaning that polymethyl(meth)acrylate allows more UV radiation to pass through. In practice materials on the surface of the earth are exposed predominantly to what is referred to as UV-A and UB-B radiation. The UV-A radiation typically has a wavelength of from 315-400 nm whereas UV-B radiation ranges from 280-315 nm. Lower wavelengths are typically blocked by the earth's atmosphere. This means that polymethyl(meth)acrylate typically is considered to be “transparent” to ultraviolet radiation.

The consequence of the foregoing is that acrylate based particles embedded near the outer surface in a polycarbonate polymer composition tend to allow UV radiation to penetrate deeper into the polycarbonate thereby increasing the amount of polycarbonate that may be affected by the effects of ultraviolet radiation, such as for example yellowing of the polymer. In addition, because these particles are typically spherical more polycarbonate may be exposed to ultraviolet radiation.

### Polycarbonate

A particularly preferred polymer for lighting applications is polycarbonate. Thus, the polymer composition (A) preferably comprises, based on the weight of the polymer composition (A) at least 60 wt. %, more preferably at least 70 wt. %, 80 wt. %, 90 wt. %, 95 wt. %, or 99 wt. % of polycarbonate (A1) and at most 30 wt. %, 20 wt. %, 10 wt. %, 5 wt. %, 1 wt. % of further components (A2).

The polycarbonate A1 preferably comprises bisphenol A polycarbonate homopolymer, which may be interfacial polycarbonate or melt polycarbonate. Interfacial polycarbonate, as is well known to the skilled person, is manufactured by reacting bisphenol A and phosgene in a two-phase liquid reaction system followed by separation of the phases and isolation of the polycarbonate. Interfacial polycarbonate typically has a very low number of phenolic hydroxyl groups, such as at most 150 ppm, at most 100 ppm, at most 50 ppm or preferably at most 25 ppm of ˜OH groups based on the weight of the polymer. Interfacial polycarbonate typically does not contain any Fries branching units contrary to melt polycarbonate. Melt polycarbonate is typically obtained by reacting bisphenol A and diphenyl carbonate via transesterification in molten state. The reaction involves relatively high temperatures and low pressures in order to advance the transesterification. In view of the process melt polycarbonate intrinsically has much higher phenolic end groups and contains a significant amount of Fries branching units.

In an aspect polymer composition (A) comprises polycarbonate as the only polymer component and accordingly does not contain another polymer. In another aspect the polymer composition comprises a further polymer component comprised in the further component(s) A2.

The polycarbonate in polymer composition (A) may be interfacial polycarbonate, melt polycarbonate or a mixture of melt and interfacial polycarbonate.

The melt flow rate (MFR) of the polycarbonate is not particularly limited and may be from 3-60 g/10 min, preferably from 5-40 g/10 min (ISO 1133, 300° C., 1.2 kg). Since lighting applications typically complex parts with at least portions of thin wall thickness it is preferred that the MFR of the polycarbonate is from 18-40, such as from 20-35 g/10 min.

The polycarbonate may be a mixture of two or more polycarbonates having mutually different MFRs. In case the polycarbonate is a mixture then the melt flow rate of the mixture is preferably from 5-40 g/10 min (ISO 1133, 300° C., 1.2 kg) and more preferably from 18-40, such as from 20-35 g/10 min.

The polycarbonate may comprise or consist of partially branched polycarbonate, which is typically obtained by reacting the bisphenol A and the phosgene or diphenyl carbonate in the presence of a branching agent such as for example 1,1,1-tris(4-hydroxyphenyl)ethane (THPE). Branched polycarbonate is known per se and is advantageously used in applications which require a high melt strength. For example, the polycarbonate may be a mixture of 10-90 wt. % of linear polycarbonate and 90-10 wt. % of branched polycarbonate, based on the combined weight of the linear and branched polycarbonate.

In an aspect of the invention where the polymer composition (A) comprises polycarbonate in an amount of at least 60 wt. %, 70 wt. %, 80 wt. %, 90 wt. %, 95 wt. %, or 99 wt. %, the melt flow rate of polymer composition (A) is preferably from 3-60, preferably 5-40 g/10 min (ISO 1133, 300° C., 1.2 kg) and more preferably from 18-40, such as from 20-35 g/10 min.

Further components A2 comprises further polymer components, non-polymer components and additives as known to the skilled person per se. For example, the additives as part of further components A2 may include anti-oxidants, flame retardants, flame retardant synergists, anti-drip agents, heat stabilisers mould release agents, colorants such as pigments or dyes and ultraviolet stabilisers. The present invention is not limited in that respect and any additive commonly used in similar applications can be comprised in the polymer composition (A) provided it retains its suitability for the intended application. In an aspect of the invention the polymer composition comprises from 0.05-0.5, preferably from 0.1-0.3 wt. % of an ultraviolet stabiliser. The polymer composition may also be free of an ultraviolet stabiliser. Preferably, the polymer composition is free of ultraviolet stabiliser. The expression “free of” as used herein means that the polymer composition has less than 0.1 wt. %, preferably less than 0.01 wt. % of ultraviolet stabiliser. The additives are comprised in the further components A2.

The polymer composition preferably comprises at least 50, more preferably at least 75 wt. % of polycarbonate, based on the weight of the polymer composition. More preferably the polymer composition comprises at least 85 wt. %, at least 90 wt. % or at least 95 wt. % of polycarbonate. It is preferred that polycarbonate is the only polymer contained in the polymer composition and that the thermoplastic composition does not contain any other polymer.

### Polymethyl(Meth)Acrylate

Another polymer often used in for lighting applications is polymethyl(meth)acrylate.

Polymethyl(meth)acrylate polymers are known to the skilled person per se, including the use thereof for optical applications. Polymethyl methacrylates are generally obtained via free radical polymerization of mixtures which comprise methyl methacrylate. These mixtures generally comprise at least 40% by weight, preferably at least 60% by weight, and particularly preferably at least 80% by weight, of methyl methacrylate, based on the weight of the monomers. Alongside this, these mixtures for preparing polymethylmethacrylates may comprise other (meth)acrylates which are copolymerisable with methyl methacrylate. The term (meth)acrylates encompasses methacrylates and acrylates, and also mixtures of the two. These monomers are well known to the skilled person. The polymethyl(meth)acrylate is not particularly limited and any commercially available material can be used. Use may be made of various poly(meth)acrylates which differ, for example in their molecular weight or in their monomeric constitution.

The weight-average molecular weight of the polymethyl(meth)acrylate may be from 20000-1000 000 g/mol, preferably from 50,000 to 500,000 g/mol and particularly preferably from 80 000 to 300 000 g/mol. Light diffusing applications based on polymethyl(meth)acrylate formulations are disclosed, for example, in U.S. Pat. Nos. 7,629,041 and 8,609,011.

Further components included in the polymer composition (A) may be further polymer components, non-polymer components and additives as known to the skilled person per se. For example, the additives may include anti-oxidants, flame retardants, flame retardant synergists, anti-drip agents, heat stabilisers mould release agents, colorants such as pigments or dyes and ultraviolet stabilisers. The present invention is not limited in that respect and any additive commonly used in similar applications can be comprised in the polymer composition (A) provided it retains its suitability for the intended application. In an aspect of the invention the polymer composition comprises from 0.05-0.5, preferably from 0.1-0.3 wt. % of an ultraviolet stabiliser. The polymer composition may be free of an ultraviolet stabiliser.

### Mixture of Polycarbonate and Polymethyl(Meth)Acrylate

In an aspect of the invention the polymer composition is based on a mixture A1 of polymethyl(meth)acrylate and polycarbonate wherein the mixture consists of polycarbonate 40-60 wt. % of polycarbonate and from 60-40 wt. % of polymethyl(meth)acrylate based on the weight of said mixture.

In this aspect the polymer composition (A) preferably comprises, based on the weight of the polymer composition (A) at least 60 wt. %, more preferably at least 70 wt. %, 80 wt. %, 90 wt. %, 95 wt. %, or 99 wt. % of such a mixture (A1) and at most 30 wt. %, 20 wt. %, 10 wt. %, 5 wt. %, 1 wt. % of further components (A2).

Further mixtures of polymethyl(meth)acrylate and polycarbonate are considered as part of the aspects wherein the polymer composition comprises at least 60 wt. % of polymethyl(meth)acrylate or polycarbonate as the case may be and as described above.

Further components A2 comprises further polymer components, non-polymer components and additives as known to the skilled person per se. For example, the additives as part of further components A2 may include anti-oxidants, flame retardants, flame retardant synergists, anti-drip agents, heat stabilisers mould release agents, colorants such as pigments or dyes and ultraviolet stabilisers. The present invention is not limited in that respect and any additive commonly used in similar applications can be comprised in the polymer composition (A) provided it retains its suitability for the intended application. In an aspect of the invention the polymer composition comprises from 0.05-0.5, preferably from 0.1-0.3 wt. % of an ultraviolet stabiliser. The polymer composition may also be free of an ultraviolet stabiliser. The additives are comprised in the further components A2.

### Light Diffusing Particles

Light diffusing particles are known to the skilled person per se and are readily available commercially. It is preferred that the light diffusing particles consist of an acrylate based resin composition or a silicone based resin composition, both of which are known to the skilled person per se. In an aspect of the invention, at least part of the light diffusing particles consist of a resin composition comprising at least one ultraviolet stabiliser. The light diffusing particles consist of an acrylate based resin composition or a silicone based resin composition. Preferably, the light diffusing particles consist of an acrylate based resin composition. Preferably, the acrylate based resin composition is a cross-linked (meth) acrylic resin. Preferably, the light diffusing particles consist of a cross-linked (meth) acrylic resin.

The silicone based resin is often also referred to as polyorganosilsesquioxane. Such resin compositions are typically cross-linked which allows the particles to substantially maintain their shape during melt blending with a polymer composition and not become stretched, deformed or even diluted with the polymer composition.

For the purpose of providing the desired light diffusion the particles preferably have a diameter of at most 100 μm, such as at most 80 μm, preferably from 0.5 to 50 μm, more preferably from 0.5 to 10 μm, even more preferably 1 to 5 μm, wherein the diameter is determined by laser diffraction according to ISO 13320:2020. Light diffusing particles having a relatively high diameter, such as from 10-50 μm, are not excluded per se, yet may be less preferred for use in polycarbonate based light diffusing plates.

The particle diameter indicates a 50% value (D50) of an integral particle size distribution obtained by a laser diffraction/scattering method. The number of particle size distributions may be single or plural. That is, it is possible to combine two or more types of light diffusing particles which differ in average particle diameter and/or resin composition. It is preferred that the light diffusing particles have a narrow particle size distribution.

The particles are preferably spherical in shape. The light diffusing particles may have a maximum diameter (Dmax) and a minimum diameter (Dmin), wherein Dmax≥Dmin and the ratio Dmax/Dmin is from 1-1.5, preferably from 1-1.2, more preferably from 1-1.05, most preferably from 1-1.01.

Examples of cross-linked silicone resin light diffusing particles include KMP590, manufactured by Shin-Etsu Chemical Co., Ltd., Tospearl 120, Tospearl 145 manufactured by Momentive Performance Materials.

Examples of cross-linked (meth) acrylic resin light diffusing particles include TECHPOLYMER MBX series, such as MBX-5, MBX-8, MBX-12, MBX-20, MBX-30, MBX-2H, MB30X-5, MB30X-8, MB30X-20, MB30X-30, MBX-25H and the like, manufactured by SEKISUI PLASTICS CO., Ltd. The MBX series of light diffusing particles are comprised of cross-linked polymethylmethacrylate, are substantially spherical and have a refractive index of 1.49. As noted, the light diffusing particles are optically transparent.

The resin composition of the light diffusing particles comprises at least one ultraviolet stabiliser. It is preferred that when the light diffusing particles comprises the ultraviolet stabiliser the polymer composition is free of the ultraviolet stabiliser.

Depending on the type of resin any known UV stabiliser for similar materials, i.e. polymers, can be used and the present invention is not limited to any specific type. Examples include hindered amine light stabilisers (HALS) and benzotriazole based light stabilisers, benzophenone based light stabilisers, triazine based light stabilisers, cyanoacrylate based light stabilisers, benzoxazine based light stabilisers. The amount of ultraviolet stabiliser is preferably from 0.01-5 wt. %, preferably from 0.03-3 wt. %, more preferably from 0.05-1 wt. % based on the weight of the resin composition of the light diffusing particles.

The amount of light diffusing particles is from 0.1-7.5 wt. %, based on the weight of the thermoplastic composition. Preferably the amount of light diffusing particles is from 0.1-5 wt. %, more preferably from 0.2-3 wt. %.

### Thermoplastic Composition

In order for a desirable light diffusion it is preferred that the refractive index of the light diffusing particles and the refractive index of the polymer composition is different. It is therefore preferred that the absolute difference between the refractive index of the polymer composition and the refractive index of the light diffusing particles is at least 0.01, preferably from 0.03-0.3, more preferably from 0.05 to 0.2, even more preferably from 0.08-0.15 when measured in accordance with ISO 489 at a wavelength of 589 nm and a temperature of 23° C. Typically the refractive index of the polymer composition is higher than the refractive index of the light diffusing particles.

The polymer composition preferably comprises or consists of polycarbonate, polymethyl(meth)acrylate or a mixture of polycarbonate and polymethyl(meth)acrylate, preferably polycarbonate.

The light diffusing particles are evenly dispersed in said polymer composition which can be achieved by known compounding techniques.

It is preferred that the thermoplastic composition comprises, based on the weight of the composition (A) from 92.5-99.9 wt. % of a polymer composition comprising A1) at least at least 60 wt. %, more preferably at least 70 wt. %, 80 wt. %, 90 wt. %, 95 wt. %, or 99 wt. % of polycarbonate (A1) and

A2) at most 30 wt. %, 20 wt. %, 10 wt. %, 5 wt. %, 1 wt. % of further components, B) from 0.1-7.5 wt. % of light diffusing particles, wherein at least part of the light diffusing particles consist of a resin composition comprising at least one ultraviolet stabiliser and wherein the resin composition is a cross-linked (meth) acrylic resin.
With regards to the polycarbonate and the resin composition of the light diffusing particles the same preferences apply as set out above.

It is preferred that the sum of the components A and B making up the thermoplastic composition total to 100 wt. %, based on the weight of the thermoplastic composition. In this preferred aspect of the invention the amount of non-polymer materials, part of the polymer composition A, may be at most 3 wt. %, preferably at most 2 wt. % more preferably at most 1 wt. % based on the weight of the polymer composition.

The thermoplastic composition in accordance of the invention is typically substantially free of materials that reduce the transmission of visible light. Thus the thermoplastic composition disclosed herein preferably does not contain inorganic particulate fillers or pigments, and/or impact modifiers. In some applications a small amount, such as at most 2 wt. %, preferably at most 1 wt. % of an inorganic pigment, such as for example titanium dioxide may be added for imparting a certain desired colour effect.

The present invention further relates to an article comprising or consisting of the thermoplastic composition disclosed herein. In particular the present invention relates to a light diffusing plate or sheet obtained by moulding the thermoplastic composition. Such article, in particular such sheet or plate, may have at least a portion having thickness of from 0.1-10 mm, preferably from 0.5-5 mm. Notwithstanding the foregoing thicker applications are not excluded per se and articles may also have at least a portion having a thickness of at most 25 mm, at most 20 mm or at most 15 mm.

Articles may be obtained by extrusion into a film, sheet, tube or profile as known to a skilled person per se. Alternatively the articles may be molded, such as for example by injection molding.

The present invention will be further elucidated based on the following non-limiting examples.

The polycarbonate (PC) used in the following experiments was a interfacial bisphenol A polycarbonate homopolymer commercially available from SABIC and having a melt volume rate (MVR) of 28 cm³/10 min in accordance with ISO 1133 (1.2 kg, 300° C.). The PC does not contain ultraviolet stabilisers.

The light diffusing particles (LD) are cross-linked polymethylmethacrylate resin particles having an average particles size of 5 μm commercially available from SEKISUI PLASTICS CO., Ltd. as Techpolymer MBX-5.

The ultraviolet stabilised light diffusing particles (LD_UV) are cross-linked polymethylmethacrylate resin particles having an average particles size of 5 μm and comprise an ultraviolet stabiliser. Except for the presence of ultraviolet stabiliser the particles are similar to the particles LD.

The ultraviolet stabiliser (UV) was 2-(2H-benzotriazol-2-yl)-4-(1,1,3,3-tetramethylbutyl)phenol commercially available as Tinuvin 5411.

Compositions were moulded into 2.5 mm mm plaques and subjected to a weathering test in accordance with ISO 11341, by exposing the plaques to filtered xenon-arc radiation with a radiation power at 340 nm of 0.5 W/m² at a temperature of 65° C. applying an inner filter of quartz and an outer filter of CIRA-soda lime glass. The plaques were exposed to ultraviolet radiation for 2246 hours.

The visible light transmission was measured in accordance with ASTM D1003-00 on a Byk Gardner Dual hazeguard.

The color properties L*, a*, b* and the resultant dE* were measured using CIE illuminant D65 and 10° observer in transmission mode, specular component excluded on an X rite 7000a spectrophotometer in accordance with ASTM E308-15 (Standard Practice for Computing the Colors of Objects by using the CIE System) The color values L**inn a*_in b*in and T % were determined before weathering of the moulded plaque. The difference color values dL*, da*, db*, dE*, dT* and dHaze were determined after weathering of the moulded plaque.

The results of the experiments are shown in Tables 1 and 2 below.

TABLE 1

| | | CE1 | CE2 | CE3 | CE4 | CE5 | E1 | E2 | E3 | E4 |
|---|---|---|---|---|---|---|---|---|---|---|
| PC | [wt. %] | 100 | 99.70 | 99.25 | 98.50 | 97.0 | 99.70 | 99.25 | 98.50 | 97.0 |
| UV | [wt. %] | | | | | | | | | |
| LD | [wt. %] | | 0.30 | 0.75 | 1.50 | 3.0 | | | | |
| LD_UV | [wt. %] | | | | | | 0.30 | 0.75 | 1.50 | 3.0 |
| L*_in | | 95.8 | 92.7 | 89.6 | 81.3 | 73.0 | 94.0 | 84.5 | 81.2 | 74.3 |
| a*_in | | −0.04 | 0.06 | 0.29 | 0.63 | 0.39 | 0.02 | 0.54 | 0.64 | 0.22 |
| b*_in | | 0.6 | 2.2 | 3.8 | 4.5 | 2.5 | 1.9 | 5.0 | 4.8 | 2.5 |
| T % | [%] | 92.5 | 90.3 | 82.2 | 67.9 | 58.4 | 89.5 | 79.4 | 67.9 | 57.4 |
| dL* | | −1.1 | 0.4 | −1.6 | −2.9 | −1.2 | −1.6 | 1.9 | −1.4 | −3.1 |
| da* | | −1.97 | −2.01 | −1.78 | −1.80 | −2.07 | −1.73 | −1.65 | −1.49 | −1.54 |
| db* | | 7.8 | 7.7 | 8.4 | 9.1 | 11.1 | 7.7 | 6.8 | 7.5 | 8.6 |
| dE* | | 8.2 | 7.9 | 8.7 | 9.7 | 11.4 | 8.1 | 7.3 | 7.8 | 9.3 |
| dT % | [%] | −4.3 | −7.4 | −8.6 | −8.8 | −9.3 | −8.3 | −8.7 | −8.5 | −8.8 |
| dhaze | [%] | 2.6 | 1.5 | 0.8 | 1.8 | 2.0 | 2.0 | 2.0 | 2.0 | 2.0 |

In the compositions of the example the ultraviolet stabiliser UV is part of the polymer composition, i.e. it is part of the polycarbonate PC.

TABLE 2

| | | CE6 | CE7 | CE8 | CE9 | CE10 | E5 | E6 | E7 | E8 |
|---|---|---|---|---|---|---|---|---|---|---|
| PC | [wt. %] | 99.85 | 99.55 | 99.10 | 98.35 | 96.85 | 99.55 | 99.10 | 98.35 | 96.85 |
| UV | [wt. %] | 0.15 | 0.15 | 0.15 | 0.15 | 0.15 | 0.15 | 0.15 | 0.15 | 0.15 |
| LD | [wt. %] | | 0.30 | 0.75 | 1.50 | 3.0 | | | | |
| LD_UV | [wt. %] | | | | | | 0.30 | 0.75 | 1.50 | 3.0 |
| L*_in | | 95.8 | 94.2 | 89.3 | 81.0 | 70.7 | 94.2 | 87.8 | 78.1 | 73.9 |
| a*_in | | −0.10 | −0.07 | 0.22 | 0.51 | 0.15 | −0.10 | 0.32 | 0.57 | 0.07 |
| b*_in | | 0.6 | 1.8 | 4.1 | 4.8 | 2.7 | 2.0 | 4.7 | 4.7 | 2.7 |
| T % | [%] | 92.4 | 90 | 81.9 | 67.4 | 58.1 | 89.6 | 78.9 | 64.9 | 57.3 |
| dL* | | −0.5 | 0.0 | −0.4 | −1.4 | 2.7 | −0.5 | −0.5 | 0.6 | −2.0 |
| da* | | −0.72 | −0.75 | −0.68 | −0.74 | −0.95 | −0.65 | −0.76 | −0.84 | −0.95 |
| db* | | 3.1 | 2.9 | 3.1 | 3.9 | 5.2 | 2.9 | 3.6 | 4.1 | 5.2 |
| dE* | | 3.2 | 3.0 | 3.2 | 4.2 | 5.9 | 3.0 | 3.7 | 4.3 | 5.6 |
| dT % | [%] | −3.0 | −5.4 | −6.7 | −7.1 | −8.1 | −5.8 | −6.8 | −7.4 | −8.1 |
| dhaze | [%] | 1.8 | 1.3 | 1.0 | 2.0 | 1.8 | 2.0 | 1.9 | 2.0 | 2.0 |

From the Tables 1 and 2 the inventors concluded that the presence of a UV stabiliser in the light diffusing particles indeed improves the weathering of the moulded part consisting of the polycarbonate and the said particles. In particular the inventors believe that the value of dE*, which is the resultant in color change, is representative for this observation. When a UV stabiliser is also added to the polycarbonate a further improvement of the color change is observed. In view of the results the present inventors believe that the amount of ultraviolet stabiliser in the polymer composition, i.e. in the polycarbonate, can be further reduced allowing a reduction in cost of manufacture of the composition. Accordingly the present inventors believe that optimisation of the type and amount of ultraviolet stabiliser both in the polymer composition, in particular the polycarbonate, and in the light diffusing particle allows cost reduction and/or improved weathering performance.

1. Thermoplastic composition comprising, based on the weight of the composition
A) from 92.5-99.9 wt. % of a polymer composition comprising polycarbonate, and
B) from 0.1-7.5 wt. % of light diffusing particles,
wherein at least part of the light diffusing particles consist of a cross-linked acrylic resin composition comprising at least one ultraviolet stabiliser.

2. The composition of claim 1 wherein the absolute difference between the refractive index of the polymer composition and the refractive index of the light diffusing particles is at least 0.01, when measured in accordance with ISO 489 at a wavelength of 589 nm and a temperature of 23° C.

3. The composition of claim 1 wherein the polymer composition comprises from 0.05-0.5 of an ultraviolet stabiliser.

4. The composition of claim 1 wherein the amount of ultraviolet stabiliser in the light diffusing particles containing said ultraviolet stabiliser is from 0.05-5 wt. %.

5. The composition of claim 1 wherein the polymer composition further comprises polymethyl(meth)acrylate.

6. The composition of claim 1 wherein the polycarbonate is an interfacial polycarbonate.

7. The composition of claim 1 wherein the polycarbonate is bisphenol A polycarbonate homopolymer.

8. Article comprising or consisting of the composition of claim 1.

9. Article of claim 8 wherein said article is a light diffusing plate or sheet obtained by molding of said composition of claim 1.

10. Article of claim 8 wherein said article is obtained by extrusion into a film, sheet, tube or profile.

11. (canceled)

12. Light diffusing particle(s) consisting of a cross-linked acrylic resin, a cross-linked polystyrene resin, or a silicone resin and comprising from 0.05-5 wt. %, based on the weight of the acrylic, polystyrene or silicone resin, of an ultraviolet stabiliser.

13. Light diffusing particle(s) of claim 12, wherein said particles have a diameter of from 0.5 to 100 μm, wherein the diameter is determined by laser diffraction according to ISO 13320:2020.

14. Light diffusing particle(s) of claim 12 wherein the particles have a maximum diameter (Dₘₐₓ) and a minimum diameter (Dₘᵢₙ), wherein Dₘₐₓ≥Dₘᵢₙ and the ratio Dₘₐₓ/Dₘᵢₙ is from 1-1.5, wherein the diameter is determined by laser diffraction according to ISO 13320:2020.
